(19) United States
(12) Patent Application Publication
(10) Pub. No.: US 2022/0288709 A1
(43) Pub. Date: Sep. 15, 2022

(54) ENVIRONMENT-FRIENDLY DUST-FREE DESKTOP CUTTING MACHINE

(71) Applicant: NANJING VORTEK MACHINERY CO., LTD., Nanjing (CN)

(72) Inventors: Yi HUA, Nanjing (CN); Xueshun ZHANG, Nanjing (CN)

(73) Assignee: NANJING VORTEK MACHINERY CO., LTD., Nanjing (CN)

(21) Appl. No.: 17/629,426

(22) PCT Filed: Nov. 25, 2020
(86) PCT No.: PCT/CN2020/131418

§ 371 Date: Jan. 24, 2022

(30) Foreign Application Priority Data
Dec. 27, 2019 (CN) 201911375315.3

(51) Int. Cl. B23D 59/00; B01D 45/16; B01D 46/24; B01D 46/00; B01D 46/48; B01D 50/20

(52) U.S. Cl. CPC B23D 59/006; B01D 45/16; B01D 46/24; B01D 46/0049; B01D 46/48; B01D 50/20; B28D 7/02

(57) ABSTRACT

An environment-friendly dust-free desktop cutting machine includes a housing and a cutting work platform arranged on the housing. The cutting work platform is provided with a saw opening. An air intake chamber is arranged under the cutting work platform, and the saw opening is configured as an air inlet of the air intake chamber at the same time. The air intake chamber is provided with an air outlet of the air intake chamber, and a horizontal centrifugal separator is installed at the air outlet of the air intake chamber. A rear end of the horizontal centrifugal separator is provided with a dust-dropping port of the separator, a first dust collecting box is arranged at the dust-dropping port of the separator, a front end of the horizontal centrifugal separator is provided with an air outlet of the separator, a filter cylinder is arranged at the air outlet of the separator.

### CROSS REFERENCE TO THE RELATED APPLICATIONS

This application is the national phase entry of International Application No. PCT/CN2020/131418, filed on Nov. 25, 2020, which is based upon and claims priority to Chinese Patent Application No. 201911375315.3, filed on Dec. 27, 2019, the entire contents of which are incorporated herein by reference.

### TECHNICAL FIELD

The present invention belongs to the technical field of cutting equipment, and more particularly, relates to an environment-friendly dust-free desktop cutting machine.

### BACKGROUND

In production and life, desktop cutting machines are used to cut wood plates, stone, ceramic tiles, and other materials. In the cutting process of these materials, a lot of dust is produced, which will endanger the health of the operators, and have an adverse impact on the surrounding environment. Therefore, many countries around the world have strict requirements for the emission of the dust. For instance, the EU standard prEN16770 stipulates that the emission of the dust from wood cutting shall be less than 100 μg/m³. The US Occupational Safety and Health Administration (OSHA) stipulates that the emission of the dust from stone cutting shall be less than 50 μg/m³ in OSHA 3902-10 2016, and a dust collecting rate shall be more than 99%.

The main technical solution of the prior dust-free desktop cutting machine is that the dust produced by cutting a workpiece is absorbed into the air intake chamber through the saw opening configured as an air inlet under the action of a negative-pressure fan, which passes through the dust duct and enters the dust filter bag. The air in the dust filter bag is firstly discharged by a negative pressure and then discharged by an air discharging port through the negative-pressure fan, so as to realize dust-free cutting.

The technical solution has the following shortcomings: (1) although the rising dust can be effectively restrained at the initial stage, the dust collecting capacity will rapidly decline since the blockage of the filter bag becomes more and more serious along with the collection of a large amount of dust; (2) it is difficult to clean the filter bag and it is liable to cause secondary pollution; (3) since the filtering efficiency of the dust filter bag is low, there is still a large amount of small-diameter dust to be discharged into the atmosphere, resulting in that the dust emission requirement of less than 50 μg/m³ cannot be satisfied. In order to satisfy this standard of this dust emission requirement, high efficiency particulate air (HEPA) filter is necessarily adopted. However, a large amount of dust produced in the cutting process will sharply lead to the blockage of HEPA filter, thus a normal operation cannot be achieved; (4) as the cutting machine needs to be frequently transported to the work site to work, the size of the cutting machine should not be too large.

Based on the above reasons, the prior desktop cutting machine cannot simultaneously satisfy the standard of the emission requirement of the dust in the environment, ensure the long-term stable operation of the equipment and have the small size. Thus, how to overcome the above problems is existing long-standing technical problems in the industry.

### SUMMARY

In order to solve the above technical problems, the objectives of the present invention are to provide an environment-friendly dust-free desktop cutting machine, which can realize dust-air pre-separation for dusty airflow, simultaneously realize dust-free cutting and a long-term stable operation of the equipment, and have relatively small size.

In order to realize the above technical objectives, the technical solutions adopted by the present invention are as follows. An environment-friendly dust-free desktop cutting machine, includes a housing and a cutting work platform arranged on the housing. The cutting work platform is provided with a saw opening, and a saw blade is installed in the saw opening. The saw blade is connected to a drive motor.

An air intake chamber is arranged under the cutting work platform, and the saw opening is configured as an air inlet of the air intake chamber at the same time. The air intake chamber is provided with an air outlet of the air intake chamber, and a horizontal centrifugal separator is installed at the air outlet of the air intake chamber.

A rear end of the horizontal centrifugal separator is provided with a dust-dropping port of the separator, a first dust collecting box is arranged at the dust-dropping port of the separator, a front end of the horizontal centrifugal separator is provided with an air outlet of the separator, a filter cylinder is arranged at the air outlet of the separator, and a negative-pressure fan is installed at an air outlet of the filter cylinder.

As a preferred technical solution, an air rotation move axis of the horizontal centrifugal separator is parallel to the cutting work platform.

As a preferred technical solution, an air discharging chamber is arranged in the housing, the drive motor of the saw blade and the negative-pressure fan are installed in the air discharging chamber, and a tail end of the air discharging chamber is provided with an air discharging port.

As a preferred technical solution, the air discharging port is provided with a soundproof cotton.

As a preferred technical solution, the bottom of the air intake chamber is provided with a large particle outlet, and a second dust collecting box is arranged at the large particle outlet.

As a preferred technical solution, a third dust collecting box is arranged under the filter cylinder.

As a preferred technical solution, the first dust collecting box, the second dust collecting box and the third dust collecting box are integrated.

As a preferred technical solution, the cutting work platform includes a main work platform and an embedded block, and the saw opening is arranged on the embedded block.

Compared with the prior art, through adopting the above technical solutions, the present invention at least has the following advantages.

(1) The high-speed airflow at the saw opening configured as the air inlet of the air intake chamber carries the dust/cuttings produced by cutting to enter the air intake chamber, and the dusty air passes through the horizontal centrifugal separator and the filter cylinder to realize the separation of dust and air. Clean air is discharged into the atmosphere through the negative-pressure fan.

(2) Most of the dust is first separated in the horizontal centrifugal separator, and only a small amount of fine dust needs to be filtered. When the filtering material is an efficient filtering material, the dust emission requirement of less than 50 μg/m3 can be achieved, thereby realizing the clean discharge. Moreover, the filter cylinder is not prone to be blocked, which greatly prolongs the period for cleaning or replacing, thereby ensuring the long-term and stable operation of the equipment.

(3) The separated dust can drop in the dust collecting box, to be convenient for cleaning.

(4) The utilization of the horizontal centrifugal separator reduces the size of the equipment, and make the equipment portable.

### BRIEF DESCRIPTION OF THE DRAWINGS

The following drawings are configured for an exemplary illustration and interpretation of the present invention, do not limit the scope of the present invention. Specifically:

FIG. 1 is a front view of the structure of an embodiment of the present invention.

FIG. 2 is a side view of the structure of the embodiment of the present invention.

FIG. 3 is a top view of the structure of the embodiment of the present invention.

FIG. 4 is a structural schematic view of a cutting work platform in the embodiment of the present invention.

FIG. 5 is a structural schematic view of a horizontal centrifugal separator in the embodiment of the present invention.

FIG. 6 is a structural schematic view of a dust collecting box in the embodiment of the present invention.

In the figures: 1—housing; 11—air discharging chamber; 12—air discharging port; 13—soundproof cotton; 14—workpiece; 2—cutting work platform; 21—main work platform; 22—embedded block; 3—saw opening; 4—saw blade; 5—drive motor; 6—air intake chamber; 61—semi-annular air intake duct; 62—large particle outlet; 7—horizontal centrifugal separator; 71—dust-dropping port of separator; 72—air outlet of separator; 73—air outlet of air intake chamber; 8—dust collecting box; 81—first dust collecting box; 82—second dust collecting box; 83—third dust collecting box; 9—filter cylinder; 10—negative-pressure fan.

### DETAILED DESCRIPTION OF THE EMBODIMENTS

The present invention is further described below in combination with the drawings and embodiments. In the following detailed description, some exemplary embodiments of the present invention are described only by descriptive means. It is obvious that those skilled in the art may recognize that the described embodiments can be modified in various methods without deviating from the spirit and scope of the present invention. Therefore, the drawings and descriptions are essentially descriptive and are not used to limit the scope of protection of claims.

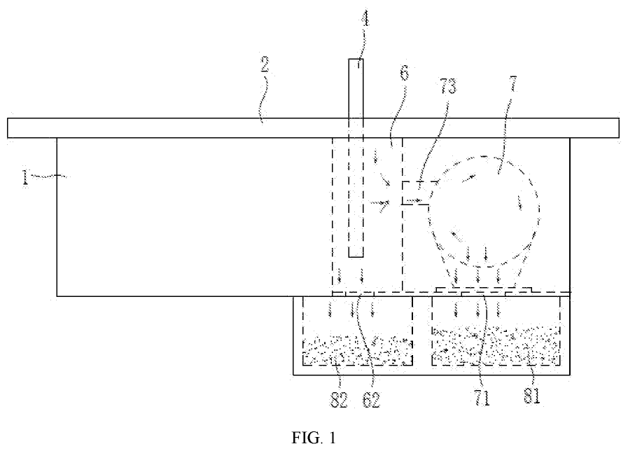

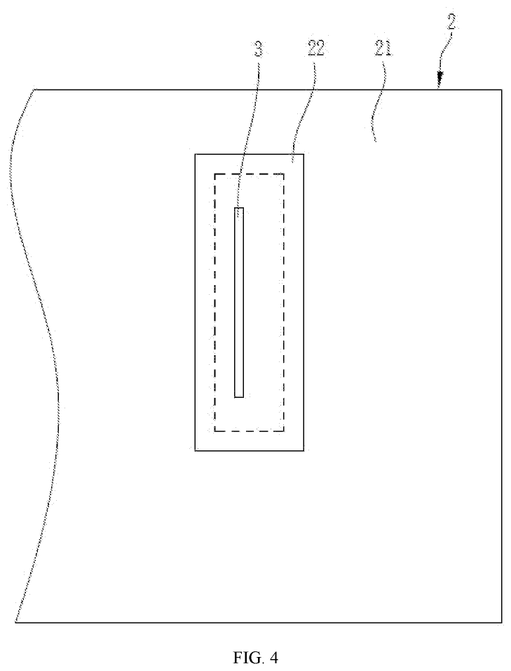

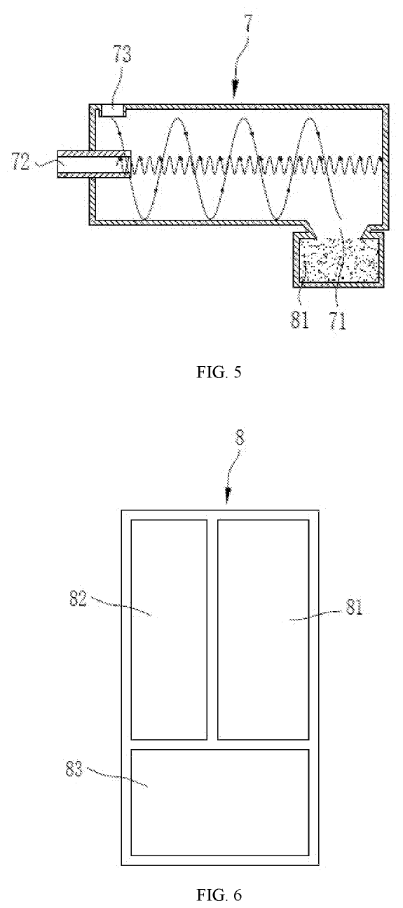

As shown in FIG. 1 and FIG. 6, the environment-friendly dust-free desktop cutting machine includes the housing 1 and the cutting work platform 2 arranged on the housing 1. The cutting work platform 2 is provided with the saw opening 3, and the saw blade 4 is installed in the saw opening. The saw blade 4 is connected to the drive motor 5. Referring to FIG. 4, in this embodiment, the cutting work platform 2 includes the main work platform 21 and the embedded block 22, and the saw opening 3 is arranged on the embedded block 22.

The air intake chamber 6 is arranged under the cutting work platform 2, and the saw opening 3 is configured as an air inlet of the air intake chamber at the same time. The air intake chamber 6 is provided with the air outlet 73 of the air intake chamber (that is, the air inlet of a separator). The semi-annular air intake duct 61 is formed in the air intake chamber 6 along the rotating track of the saw blade, which facilitates the rapid flow of dusty air towards the air outlet of the air intake chamber and avoids the overflow of dust out of the saw opening 3. In this way, it is ensured that the dust emission concentration in the working environment is less than 50 μg/m³, thereby achieving clean emissions. The horizontal centrifugal separator 7 is installed at the air outlet 73 of the air intake chamber.

The rear end of the horizontal centrifugal separator 7 is provided with the dust-dropping port 71 of the separator, and the first dust collecting box 81 is arranged at the dust-dropping port 71 of the separator. The front end of the horizontal centrifugal separator 7 is provided with the air outlet 72 of the separator, and the filter cylinder 9 is arranged at the air outlet 72 of the separator. The negative-pressure fan 10 is installed at the air outlet of the filter cylinder 9, and the third dust collecting box 83 is arranged under the filter cylinder 9. After being blew off, the dust filtered by the filter cylinder 9 will drop in the third dust collecting box 83, so that the filter cylinder can be cleaned. The filtration adopts a cylindrical filtration, which has the advantage of providing a large filtration area in a small space.

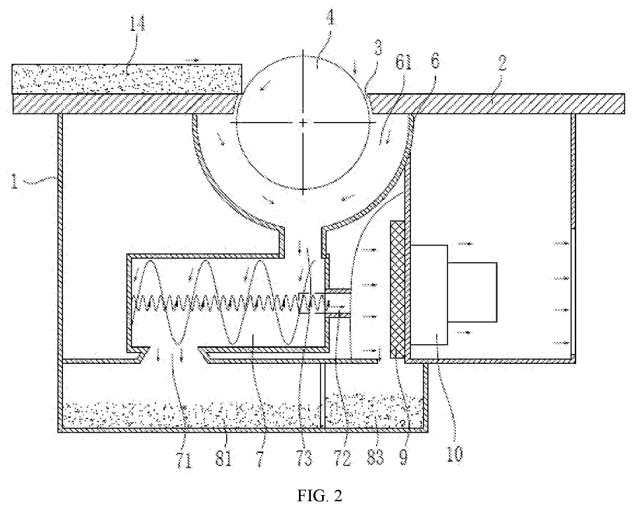

Referring to FIG. 2, the air rotation move axis of the horizontal centrifugal separator 7 is parallel to the cutting work platform 2. After entering the housing of the separator, the dusty air spirals and moves forward along the inner wall of the housing, so that the dusty air forms a spiral air flow and moves forward in a fixed direction. When the dusty air is spiraling and moving at a high speed, the vast majority of dust particles in the air flow reach the inner wall of the housing under the action of centrifugal force and are separated from the air. After arriving at the rear end of the separator, the separated dust particles enter the dust-dropping port 71 of the separator in a tangential direction and drop in the first dust collecting box 81, to complete the separation of dust and air. The separated air turns back at the rear end and leaves the separator from the air outlet 72 of the separator. The horizontal structure of the centrifugal separator can reduce the height and size of the equipment, and make the equipment portable.

During the specific installation, the portion between the lower portion of the embedded block 22 and the main work platform 21 conducts sealing, and the portion between the lower portion of the main work platform 21 and the upper portion of the air intake chamber 6 conducts sealing. The wind generated by the negative-pressure fan 10 can only enter from the saw opening 3 configured as the air inlet of the air intake chamber at the same time, and the operation such as the replacement of the saw blade can be carried out conveniently after the embedded block 22 is removed. During work, a wind speed at the air inlet of the air intake chamber is preferably greater than the linear speed of the rotation of the saw blade 4, so that a high-speed airflow can effectively absorb the dust produced by cutting to enter the air intake chamber 6.

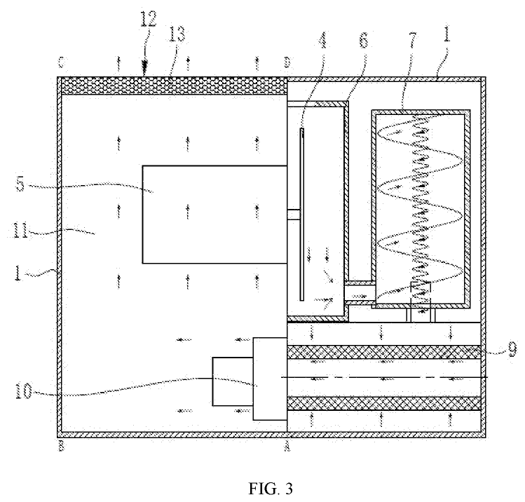

Referring to FIG. 3, the air discharging chamber 11 is arranged in the housing 1, and the drive motor 5 of the saw blade and the negative-pressure fan 10 are installed in the air discharging chamber 11. The tail end (the portion between C and D) of the air discharging chamber 11 is provided with the air discharging port 12, and the air discharging port 12 is provided with the soundproof cotton 13. The soundproof cotton 13 can effectively reduce the noise generated by the drive motor of the saw blade and the negative-pressure fan. It should be noted that the air discharging port can be arranged between A and B, B and C, as well as C and D in FIG. 3. Preferably, the present invention takes the portion between C and D as the air outlet in order to take away the heat generated by the motor when the wind passes by the surface of the motor, so as to prevent the motor from overheating.

Referring to FIG. 1, the bottom of the air intake chamber 6 is provided with the large particle outlet 62, and the second dust collecting box 82 is arranged at the large particle outlet 62. Referring to FIG. 6, in this embodiment, the first dust collecting box 81, the second dust collecting box 82, and the third dust collecting box 83 are integrated to be the dust collecting box 8. The first dust collecting box 81 is used to collect the dust produced by the horizontal centrifugal separator, the second dust collecting box 82 is used to collect the relatively large particles in the air intake chamber, and the third dust collecting box 83 is used to collect the dust in the filter cylinder.

Referring to FIGS. 1 to 3, the working principle of the present invention is as follows: when the saw blade 4 cuts the workpiece 14 at a high-speed rotation, it should be ensured that the wind speed at the saw opening 3 (the air inlet of the air intake chamber) is greater than the linear speed of the rotation of the saw blade 4, so that the high-speed airflow at the air inlet of the air intake chamber can effectively carry all the dust/cuttings produced by cutting to enter the air intake chamber 6, and the dusty air passes through the horizontal centrifugal separator 7 and the filter cylinder 9 to realize the separation of dust and air. Clean air is discharged into the atmosphere through the negative-pressure fan 10. In this way, most of the dust is first separated in the horizontal centrifugal separator 7, and only a small amount of fine dust needs to be filtered. When the filtering material is an efficient filtering material, the dust emission requirement of less than 50 μg/m³ can be achieved, thereby realizing the clean discharge. Moreover, the filter cylinder is not prone to be blocked, which greatly prolongs the period for cleaning or replacing, thereby ensuring the long-term and stable operation of the equipment.

The above only describes an exemplary specific embodiment of the present invention and is not used to limit the scope of the present invention. Any equivalent changes and modifications made by those skilled in the art without departing from the conceptions and principles of the present invention shall fall within the scope of the protection of the present invention.

What is claimed is:

1. An environment-friendly dust-free desktop cutting machine, comprising a housing and a cutting work platform arranged on the housing; wherein the cutting work platform is provided with a saw opening, and a saw blade is installed in the saw opening; the saw blade is connected to a drive motor;
an air intake chamber is arranged under the cutting work platform, and the saw opening is configured as an air inlet of the air intake chamber; the air intake chamber is provided with an air outlet of the air intake chamber, and a horizontal centrifugal separator is installed at the air outlet of the air intake chamber;
a rear end of the horizontal centrifugal separator is provided with a dust-dropping port of the horizontal centrifugal separator, a first dust collecting box is arranged at the dust-dropping port of the horizontal centrifugal separator, a front end of the horizontal centrifugal separator is provided with an air outlet of the horizontal centrifugal separator, a filter cylinder is arranged at the air outlet of the horizontal centrifugal separator, and a negative-pressure fan is installed at an air outlet of the filter cylinder.

2. The environment-friendly dust-free desktop cutting machine according to claim 1, wherein an air rotation move axis of the horizontal centrifugal separator is parallel to the cutting work platform.

3. The environment-friendly dust-free desktop cutting machine according to claim 1, wherein an air discharging chamber is arranged in the housing, the drive motor and the negative-pressure fan are installed in the air discharging chamber, and a tail end of the air discharging chamber is provided with an air discharging port.

4. The environment-friendly dust-free desktop cutting machine according to claim 3, wherein the air discharging port is provided with a soundproof cotton.

5. The environment-friendly dust-free desktop cutting machine according to claim 1, wherein a bottom of the air intake chamber is provided with a large particle outlet, and a second dust collecting box is arranged at the large particle outlet.

6. The environment-friendly dust-free desktop cutting machine according to claim 5, wherein a third dust collecting box is arranged under the filter cylinder.

7. The environment-friendly dust-free desktop cutting machine according to claim 6, wherein the first dust collecting box, the second dust collecting box and the third dust collecting box are integrated.

8. The environment-friendly dust-free desktop cutting machine according to claim 1, wherein the cutting work platform comprises a main work platform and an embedded block, and the saw opening is arranged on the embedded block.

9. The environment-friendly dust-free desktop cutting machine according to claim 2, wherein the cutting work platform comprises a main work platform and an embedded block, and the saw opening is arranged on the embedded block.

10. The environment-friendly dust-free desktop cutting machine according to claim 3, wherein the cutting work platform comprises a main work platform and an embedded block, and the saw opening is arranged on the embedded block.

11. The environment-friendly dust-free desktop cutting machine according to claim 4, wherein the cutting work platform comprises a main work platform and an embedded block, and the saw opening is arranged on the embedded block.

12. The environment-friendly dust-free desktop cutting machine according to claim 5, wherein the cutting work platform comprises a main work platform and an embedded block, and the saw opening is arranged on the embedded block.

13. The environment-friendly dust-free desktop cutting machine according to claim 6, wherein the cutting work platform comprises a main work platform and an embedded block, and the saw opening is arranged on the embedded block.

14. The environment-friendly dust-free desktop cutting machine according to claim 7, wherein the cutting work platform comprises a main work platform and an embedded block, and the saw opening is arranged on the embedded block.
